(19) United States
(12) Patent Application Publication
(10) Pub. No.: US 2006/0238472 A1
(43) Pub. Date: Oct. 26, 2006

(54) Driver of display device

(76) Inventors: Eung-Sang Lee, Yonginsi (KR); Byoung-Suk Kim, Seoul (KR); Myeong-Su Kim, Suwon-city (KR)

Correspondence Address: CANTOR COLBURN, LLP, 55 GRIFFIN ROAD SOUTH, BLOOMFIELD, CT, 06002, US

(21) Appl. No.: 11/384,993

(22) Filed: Mar. 20, 2006

(30) Foreign Application Priority Data
Apr. 22, 2005 (KR) 10-2005-0033508

(51) Int. Cl. G09G 3/36

(52) U.S. Cl. 345/89

(57) ABSTRACT

A driver of a display device is provided. The driver for a display device includes a signal controller receiving first and second input image data, converting the first input image data into first output image data having a grayscale higher than that of the first input image data and converting the second input image data into second output image data having a grayscale lower than that of the second input image data; and a data driver converting the first and second output image data received from the signal controller into first and second data voltages and applying the first and second data voltages to corresponding pixels, respectively.

This application relies on claims priority upon to Korean Patent application No. 10-2005-0033508 filed on Apr. 22, 2005, and all the benefits accruing therefrom under 35 U.S.C. §119, the contents of which are herein incorporated by reference in its entirety.

### BACKGROUND OF THE INVENTION

(a) Field of the Invention

The present invention provides a driver for a display device, and more particularly, a driver for a display device that is capable of preventing a decrease in an aperture ratio and improving display quality and the side visibility of a display device without forming additional cut portions.

(b) Description of the Related Art

A liquid crystal display (LCD), which is one of flat panel displays being most widely used, includes two panels having electric field generating electrodes such as pixel electrodes and a common electrode, and a liquid crystal layer interposed therebetween. The liquid crystal display displays an image by applying a voltage to the electric field generating electrodes, generating an electric field in the liquid crystal layer, and determining alignment of liquid crystal molecules in the liquid crystal layer to control polarization of incident light.

Among such liquid crystal displays, a liquid crystal display with a vertical alignment mode in which liquid crystal molecules are arranged such that major axes of the liquid crystal molecules are perpendicular to the upper and lower panels in the state that no electric field is generated have attracted attention, since it has a high contrast ratio and can easily provide a wide reference viewing angle.

As methods of embodying a wide viewing angle in a liquid crystal display with a vertical alignment mode, a method of forming cut portions in the electric field generating electrodes, a method of forming protrusions on the electric field generating electrodes, and the like are known. Since the direction in which the liquid crystal molecules are tilted can be determined by the use of the cut portions and the protrusions, the reference viewing angle can be widened by variously arranging the cut portions and the protrusions to distribute the tilt direction of the liquid crystal molecules in various directions. A reference viewing angle means a viewing angle having a 1:10 contrast ratio or a marginal angle for luminance inversion between grayscales.

However, a vertically aligned type of liquid crystal display has a problem of lower side visibility than front visibility. For example, in a patterned vertically aligned (PVA) type of liquid crystal display having cut portions, images become brighter when viewed further away from the center of the front side, and in the worst case the difference of luminance between high grayscales disappears, and the quality of the images may be deteriorated.

A method has been proposed to solve the problem, which is to divide a pixel into two sub-pixels, combine the two sub-pixels to form a capacitive coupling, and apply a voltage directly to one of the sub-pixels and to induce a voltage drop to the other sub-pixel due to the capacitive coupling, to cause different transmittances for each sub-pixel by having different voltages applied to each.

However, this method has a disadvantage in that precisely adjusting the transmittance of two sub-pixels to a high degree is required, and moreover, the voltage combinations for each color should be changed since light transmittance differs from one color to another, while the change of voltage combinations for each color is not possible. In addition, a decline of the aperture ratio due to an addition of a conductive body for the capacitive coupling and division of a pixel into sub-pixels occurs, and there is a problem of a transmittance decrease due to a voltage drop induced from the capacitive coupling.

### SUMMARY OF THE INVENTION

The present invention provides a driver for a display device in which input image data is converted into one of a pair of high and low grayscale conversion data, a grayscale voltage is generated for the converted data, and the grayscale voltage using high grayscale conversion data or low grayscale conversion data according to a predetermined scheme is applied to a pixel.

In an exemplary embodiment, there is provided a driver for a display device having a plurality of pixels disposed in a matrix including: a signal controller receiving first and second input image data, converting the first input image data into first output image data having a grayscale higher than that of the first input image data and converting the second input image data into second output image data having a grayscale lower than that of the second input image data; and a data driver converting the first and second output image data received from the signal controller into first and second data voltages and applying the first and second data voltages to corresponding pixels, respectively.

In another exemplary embodiment, there is provided a display apparatus including a plurality of pixels disposed in a matrix; a grayscale voltage generator which generates first and second grayscale voltage sets; and a data driver which converts first image data into a first grayscale voltage among the first grayscale voltage set and applies the first grayscale voltage to a corresponding pixel as a first data voltage, and converts second image data into a second grayscale voltage among the second grayscale voltage set and applies the second grayscale voltage to a corresponding pixel as a second data voltage, wherein the pixels applied with the first data voltage are brighter than the pixels applied with the second data voltage.

In another exemplary embodiment, there is provided a display apparatus including a plurality of pixels arranged in a matrix; a data driver which receives a plurality of input image data, converts the input image data into a data voltage, and applies the data voltage to the corresponding pixels; and a plurality of input image data including the first and second input image data having the same value. The first and second input image data are converted into first and second data voltages, respectively, and the luminance of a pixel applied with the first data voltage and the luminance of a pixel applied with the second data voltage are different from each other.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram of an exemplary embodiment a driver for display devices according to the present invention;

FIG. 2 is a diagram of an equivalent circuit for an exemplary embodiment of a pixel of a driver for display devices according to the present invention;

FIG. 3 is a graph showing exemplary embodiments of a high grayscale gamma curve, a low grayscale gamma curve, and an original gamma curve according to the present invention;

FIG. 4 is a diagram showing an exemplary embodiment of display schemes of output image data according to the present invention; and

FIG. 5 is a diagram showing another exemplary embodiment of display schemes of output image data according to the present invention.

### DETAILED DESCRIPTION OF THE INVENTION

Hereinafter, exemplary embodiments of the present invention will be described in detail with reference to the attached drawings such that the present invention can be easily put into practice by those skilled in the art.

In the drawings, thicknesses are enlarged for the purpose of clearly illustrating layers and areas. In addition, like elements are denoted by like reference numerals throughout the specification. If it is mentioned that a layer, a film, an area, or a plate is placed on a different element, it includes a case that the layer, film, area, or plate is placed right on the different element, as well as a case that another element is disposed therebetween. On the contrary, if it is mentioned that one element is placed right on another element, it means that no element is disposed therebetween.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below”, “lower”, “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Now, an exemplary embodiment a driver for display devices according to the present invention will be described in detail with reference to the accompanying drawings, and a driver for a display device will be exemplified.

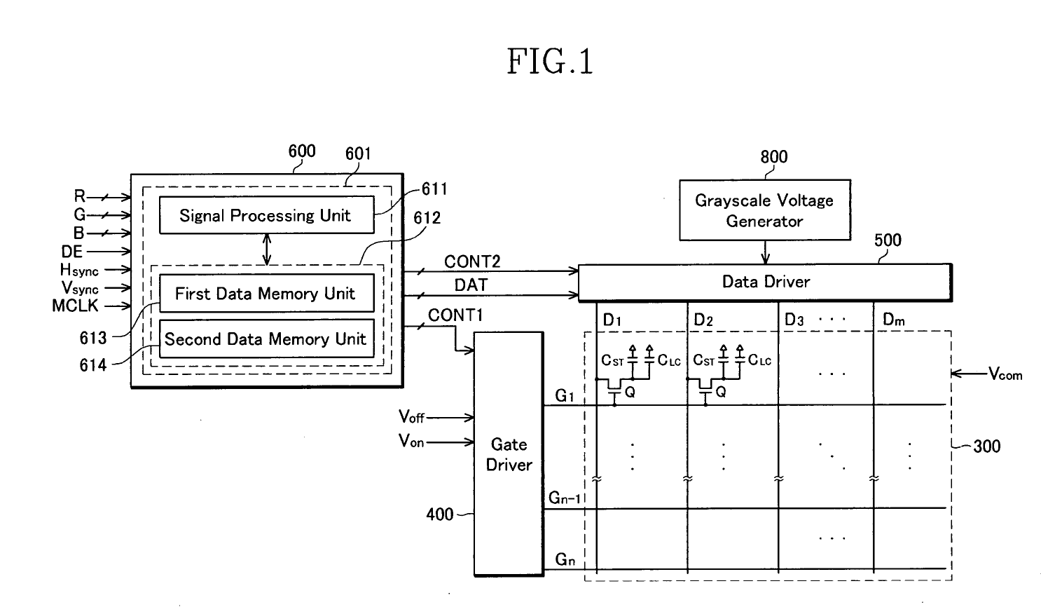

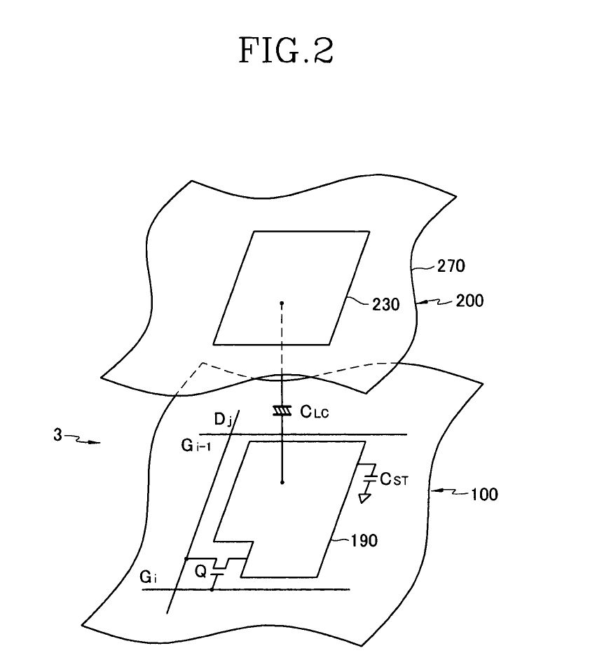

FIG. 1 is a block diagram of an exemplary embodiment of a driver for display devices according to the present invention, and FIG. 2 is a diagram of an exemplary embodiment of an equivalent circuit for a pixel of a driver for display devices according to the present invention.

Referring to FIG. 1, an exemplary embodiment of a driver for display devices according to the present invention includes a liquid crystal panel assembly 300, a gate driver 400 connected thereto, a data driver 500, a grayscale voltage generator 800 connected to the data driver 500, and a signal controller 600 which controls other components

Referring to FIG. 2 circuit, the liquid crystal panel assembly 300 includes a plurality of display lines G₁ to Gₙ and D₁ to Dₘ and a plurality of pixels connected thereto, which are disposed in a matrix. The liquid crystal panel assembly 300 further includes lower and upper display substrates 100 and 200 facing each other, and a liquid crystal layer 3 interposed therebetween.

Display signal lines G₁ to Gₙ and D₁ to Dₘ include a plurality of gate lines G₁ to Gₙ which transmit gate signals (called “scanning signal”) and data lines D₁ to Dₘ which transmit data signals. The gate lines G₁ to Gₙ extend substantially in a row direction and in parallel to each other, and the data lines D₁ to Dₘ extend substantially in a column direction and in parallel to each other. The gate lines and data lines, G₁ to Gₙ and D₁ to Dₘ, respectively, are substantially perpendicular to each other.

Each pixel, for example a pixel denoted by the i-th gate line Gᵢ and the j-th data line Dⱼ, includes a switching element Q connected to the gate line Gᵢ and the data line Dⱼ, a liquid crystal capacitor C_{LC} which is connected thereto, and a storage capacitor C_{ST}. In alternative exemplary embodiments, the storage capacitor C_{ST} may be omitted.

The switching element Q of each pixel includes a thin film transistor (not shown) which is disposed in the lower substrate 100. The switching element Q is a three-port element having a control port connected to gate lines G₁ to Gₙ, an input port connected to data lines D₁ to Dₘ, and an output port connected to the liquid crystal capacitor C_{LC} and the storage capacitor C_{ST}.

The liquid crystal capacitor C_{LC} has two ports, one port of which is a pixel electrode 190 on the lower substrate 100 and the other port of which is a common electrode 270 on the upper substrate 200. A liquid crystal layer 3 is disposed between the pixel and common electrodes 190 and 270 and functions as a dielectric material. Referring to FIG. 2, the pixel electrode 190 is connected to the switching element Q, the common electrode 270 is formed on a front side of the upper substrate 200 and a common voltage V_{com} is applied thereto. In alternative exemplary embodiments, the common electrode 270 may be formed on the lower substrate 100, and in this case, at least one of the two electrodes 190 and 270 may be formed in a shape of a line or a bar.

The storage capacitor C_{ST} which supports the function of the liquid crystal capacitor C_{LC} is formed by overlapping an additional signal line (not shown) included in the lower substrate 100 and the pixel electrode 190 with a dielectric material therebetween, and a predetermined voltage including a common voltage is applied to the additional signal line. In alternative exemplary embodiments, a storage capacitor C_{ST} may be formed by overlapping the pixel electrode 190 and a gate line located directly thereabove in the previous stage by the medium of an insulator.

In order to implement a color display, each pixel may display a predetermined color of primary colors substantially constantly (space division) or each pixel may display the primary colors alternately according to time (time division), so that a required color is recognized from a spatial combination for a period of time. The primary colors may include, but are not limited to, red, green, and blue.

FIG. 2, as an exemplary embodiment of space division, shows that a pixel includes a color filter 230 which is included in an area of the upper substrate 200, to display one of the primary colors. In alternative exemplary embodiments, the color filter 230 may be disposed above or below the pixel electrode 190 on the lower substrate 100.

On the outer side of at least one of the two substrates 100 and 200 of the liquid crystal panel assembly 300, a polarizer (not shown) which polarizes light may be attached.

Referring again to FIG. 1, a grayscale voltage generator 800 generates two pairs of grayscale voltages related to the transmittance of a pixel. One pair of voltages has positive values relative to the common voltage, and the other pair of voltages has negative values relative to the common voltage

A gate driver 400 is connected to gate lines G₁ to Gₙ of the liquid crystal panel assembly 300, and it applies a gate signal which is a combination of a received gate-on voltage Vₒₙ and gate-off voltage V_{off}.

A data driver 500 is connected to the data lines D₁ to Dₘ of the liquid crystal panel assembly 300, and it selects a grayscale voltage received from a grayscale voltage generator 800 and applies the selected voltage as a data voltage to a pixel.

The gate driver 400 or data driver 500 may be built as a chip of an integrated circuit directly on the liquid crystal panel assembly 300, or may be disposed on a flexible printed circuit film (not shown) as a tape carrier package and be attached to the liquid crystal panel assembly 300. In alternative embodiments, the gate driver 400 or the data driver 500 together with the display signal lines G₁ to Gₙ and D₁ to Dₘ and a switching element Q including a thin film transistor may be disposed on the liquid crystal panel assembly 300.

The signal controller 600 includes an image data compensation unit 601 and controls the operation of the gate driver 400 and data driver 500. Now, the operations of the liquid crystal display will be described in detail.

The signal controller 600 receives input image signals R, G, and B, input control signals, for example a vertical synchronization signal H_{sync} and a horizontal synchronization signal V_{sync}, a main clock signal MCLK, and a data enable signal DE which controls the input image signals from an external graphics controller.

The signal controller 600 processes the input image signals R, G, and B appropriately based on the input image signals R, G, and B and the input control signals according to the operating conditions of the liquid crystal panel assembly 300, generates a gate control signal CONT1 and a data control signal CONT2, and transmits the gate control signal CONT1 to the gate driver 400 and transmits the data control signal CONT2 and a processed image data DAT to the data driver 500.

The gate control signal CONT1 may include a scan start signal STV which indicates to start scanning and at least one clock signal which controls the output time of a gate-on voltage. In addition, the gate control signal CONT1 may include an output enable signal OE which limits the continuation time of a gate-on signal.

The data control signal CONT2 may include a horizontal synchronization signal STH which informs of transmission of data for a row of pixels, a load signal which requests to load corresponding data voltages to the data lines D₁ to Dₘ, and a data clock signal. The data control signal CONT2 may also include an inversion signal RVS which inverts the polarity of data voltages relative to the common electrode voltage (hereinafter, referred to as polarity of data voltage).

According to the control signal CONT2 from the signal controller 600, the data driver 500 receives image data DAT for a row of pixels and selects a grayscale voltage corresponding to each image data DAT among grayscale voltages received from a grayscale voltage generating unit 800, and converts the image data DAT into a corresponding analog data voltage and applies the data voltage to the corresponding data lines D₁ to Dₘ.

The gate driver 400 applies a gate-on voltage to the gate lines G₁ to Gₙ sequentially according to the gate control signal CONT1 received from the signal controller 600 and thereby turns on the switching element Q connected to the gate lines G₁ to Gₙ. Thereby the data voltages applied to the data lines are applied to a corresponding pixel through the turned-on switching element Q.

The difference between a data voltage applied to a pixel and the common voltage V_{com} is a stored voltage of the liquid crystal capacitor C_{LC}, i.e., a pixel voltage.

The liquid crystal molecules of the liquid crystal layer 3 are arranged differently according to the magnitude of the pixel voltage, and thereby the polarized light passing through the liquid crystal layer 3 is changed. The change of light polarized by a polarizer (not shown) attached to the display substrates 100 and 200 results in a change of light transmittance, and the luminance of a pixel is determined accordingly.

The processes described above are repeated every horizontal cycle (a cycle of a horizontal synchronization signal and a gate enabling signal). Gate-on voltages are applied to all the gate lines G₁ to Gₙ sequentially during a frame and thereby the data voltages are applied to all gate lines G₁ to Gₙ. After a frame is over, the next frame starts, and the status of an inversion signal RVS applied to the data driver 500 is controlled so that the polarity of the data voltage applied to each pixel is inverted every predetermined number of frames (“frame inversion”). At this time, the polarity of the data voltage at a data line may be changed (for example, row inversion, point inversion), and additionally, the polarities of the data voltages induced concurrently through adjacent data lines may be different (for example, column inversion, point inversion) according to the characteristic of the inversion signal RVS.

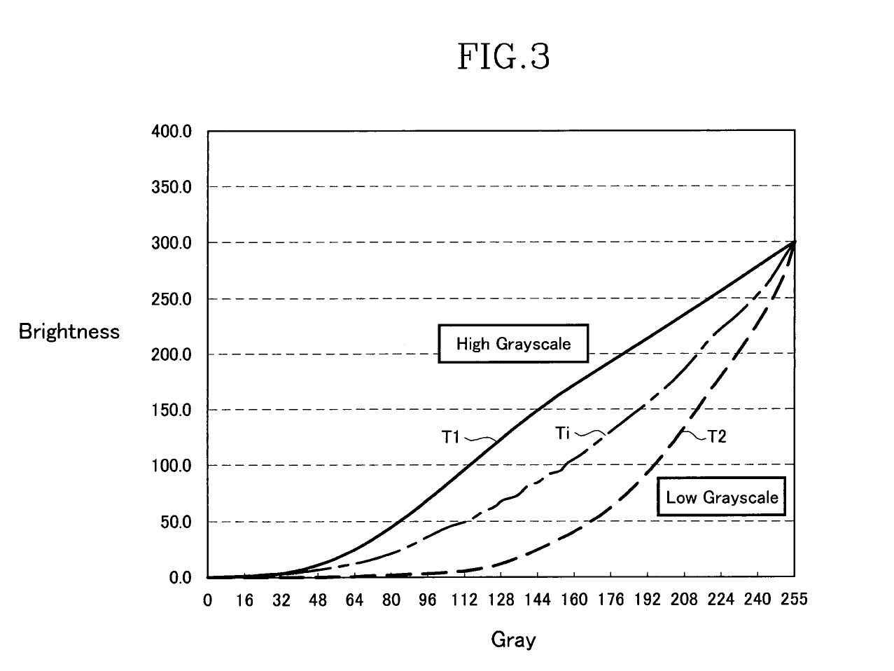

Now, referring to FIGS. 3 to 5, exemplary embodiments of the data processes performed in a signal controller 600 according to the present invention will be explained.

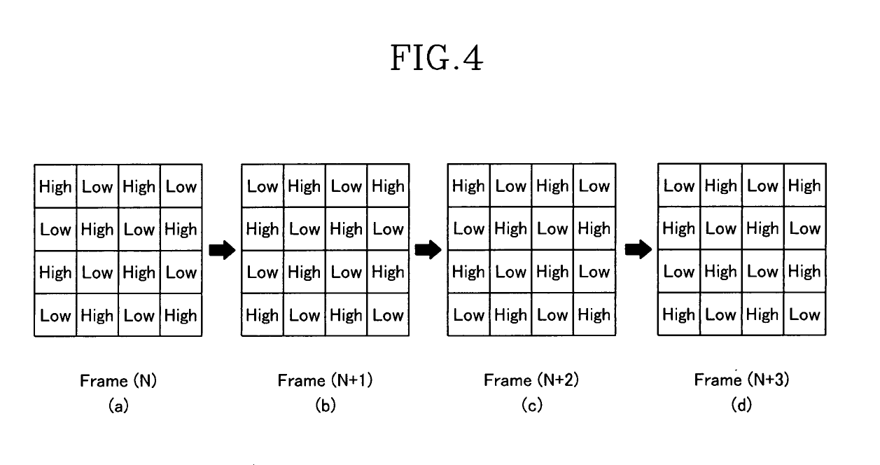

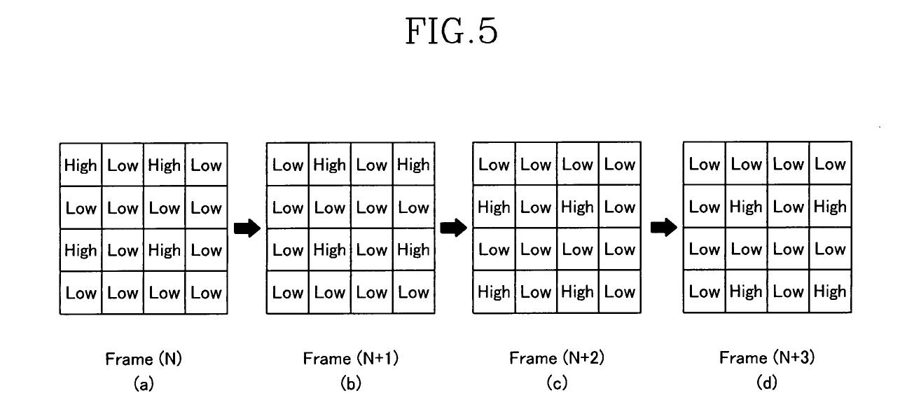

FIG. 3 is a graph showing exemplary embodiments of a high grayscale gamma curve, a low grayscale gamma curve, and an original gamma curve according to the present invention, FIG. 4 is a diagram showing an exemplary embodiment of display schemes of output image data according to the present invention, and FIG. 5 is a diagram showing an other exemplary embodiment of display schemes of output image data according to the present invention.

As described above referring to FIG. 1, the signal controller 600 includes an image data compensation unit 601. The image data compensation unit 601 includes a signal processing unit 611 and a data memory device 612 connected to the signal processing unit 611. The data memory device 612 includes first and second data memory units 613 and 614.

The first and second data memory units 613 and 614 may be storage devices such as ROMs or RAMs, or lookup tables, but they are not limited to the devices or look-up tables and may be different types of memory elements.

The first and second data memory units 613 and 614 record conversion data corresponding to image data having each grayscale. The converted data stored in the first data memory unit 613 has a higher grayscale than that of the original image data (thereby hereinafter referred to as “high grayscale conversion data”), and conversion data stored in the second data memory unit 613 has a lower grayscale than that of the original image data (thereby hereinafter referred to as “low grayscale conversion data”).

If a luminance of the high grayscale conversion data is drawn as a function of the original image data, the result is the curve T1 of FIG. 3 (hereinafter referred to as “high grayscale gamma curve”), and if a luminance of the low grayscale conversion data is drawn as a function of original image data, the result is the curve T2 of FIG. 3 (hereinafter referred to as “low grayscale gamma curve”). The curve Ti represents a luminance of the original image data grayscale drawn as a function of a grayscale (hereinafter, referred to as “original gamma curve”).

Here, it is preferable that the curve resulting from averaging the high and low grayscale gamma curves may be the original gamma curve Ti. At this time, the average may mean an average with a weighting ratio of 1:1, or a weighted average with one curve, for example the low grayscale gamma curve T2, heavily weighted. For example, the number of the weight may be three, and in this case the average is called an average with a weighting ratio of 1:3. In the case of an average with a weighting ratio of 1:3, the weighted average gamma curve is obtained by summing three times a value (luminance) of the low grayscale gamma curve and a value (luminance) of the high grayscale gamma curve, divided by four for each original image data. At this time, the difference between a value of the low grayscale gamma curve and a value of the high grayscale gamma curve may be two or more grades.

However, a luminance of a liquid crystal display device may be different according to a viewing angle and accordingly it is difficult for the average of the high and low grayscale gamma curves T1 and T2 to be the original gamma curve Ti at every viewing angle. High and low grayscale conversion data may be determined so that the average gamma curve is equal to the original gamma curve at least when the display device is viewed from the front. High and low grayscale conversion data may also be determined, so that the average of the high and low grayscale gamma curves T1 and T2 would be the closest to the original gamma curve Ti at the other viewing angles, for example at a specific reference viewing angle. In exemplary embodiments, the ratio between the number of pixels applied with high and low grayscale conversion data may be constant.

Referring again to FIG. 1, the signal processing unit 611 of the signal controller 600 finds conversion data corresponding to each input image data R, G, and B either in the first data memory unit 613 or in the second memory unit 614 of the data memory device 612, and transmits the converted data as output image data. Hereinafter, output image data chosen from the first data memory unit 613 is referred to as high grayscale output (image) data, and output image data chosen from the second data memory unit 614 is referred to as low grayscale output (image) data. One of the two output data is referred to as a different type of output image data in relation to the other output data.

The type of output image data, i.e., the high or low grayscale output data that should be selected, is determined by the ratio between the high and low grayscale output data, the frame number of input image data, and the position of the pixel for which the image data is designated. These schemes are shown on FIGS. 4 and 5.

FIG. 4 shows an exemplary embodiment where the ratio between the high and low grayscale output data is 1:1. As described above, the curve of the weighed average of high and low grayscale gamma curves with a weighting ratio of 1:1 may be identical to the original gamma curve.

Different types of output data are assigned to the adjacent pixels of a specific pixel in each frame. In other words, if the high grayscale output data is assigned to a specific pixel, the low grayscale output data are assigned to the upper, lower, left, and right pixels that may be adjacent to the pixel with the high grayscale output data. Alternatively, if a low grayscale output data is assigned to a specific pixel, high grayscale output data are assigned to the upper, lower, left, and right pixels that may be adjacent to the pixel with the low grayscale output data.

In addition, the types of output image data corresponding to pixels are different between the adjacent frames. In other words, if the high grayscale output image data is selected in a pixel a specific frame, then the low grayscale output data is selected in the corresponding pixel of the previous frame and in the next frame. FIG. 4 shows the types of output image data from N-th frames to (N+3)-th frames.

FIG. 5 shows the case that the ratio between the high and low grayscale output data is 1:3. As described above, the average curve of the high and low grayscale gamma curves with a weighting ratio of 1:3 may be equal to the original gamma curve.

In this case, among four adjacent pixels which are arranged in a 2×2 matrix (hereinafter referred to as a unit pixel matrix) in each frame, high grayscale output data is assigned to a pixel, and low grayscale output data is assigned to the remaining three pixels. In FIG. 5, positions of pixels to which the high grayscale output data are applied in all the unit pixel matrixes are the same in each frame. Alternatively, the positions of pixels to which the high grayscale output data is applied within the unit pixel matrix may be different.

High grayscale output data is assigned to each pixel during one frame of the four continuous frames, and low grayscale output data is assigned to the respective pixel during the remaining three frames of the four continuous frames. In exemplary embodiments, the position of a pixel to which a high grayscale output data is assigned in each unit pixel matrix is periodically changed with a period of four frames

In the upper left unit pixel matrix of FIG. 5, the positions of pixels to which a high grayscale output data is assigned is the upper-left in the N-th frame, the upper-right in the (N+1)-th frame, the lower-left in the (N+2)-th frame, and the lower-right in the (N+3)-th frame. This is the same in the other unit pixel matrixes. In other exemplary embodiments, the positions of pixels to which the high grayscale output data are applied in each unit pixel matrix may be changed in various ways.

When the signal processing unit 611 determines which position of a pixel image data is for, it first determines which pixel row the image data is for and then determines which pixel the image data is for in the pixel row. To determine the number of a pixel row, a horizontal synchronization signal H_{sync} may be used, and to determine the number of a frame, a vertical synchronization signal V_{sync} may be used. In alternative exemplary embodiments the number of a pixel row and the number of a frame may be determined by using an additional counter or other control signals.

Advantageously, in the exemplary embodiments described above, the front and side visibilities can be improved.

In alternative exemplary embodiments the image data for a pixel may be converted into the high grayscale output image data once and into a low grayscale output image data the next time. In this case, the data voltage must be applied twice for input image data, so the frequency of the output frame will be double that of the input frame. If the frequency becomes high in this way, there is a further advantage in that the difference between high grayscale output data and low grayscale output data can not be easily recognized by the naked eye.

In additional alternative exemplary embodiments, the input image data may not be converted and two grayscale voltages may be generated, where one of which may be selected. The gamma curves of these two grayscale voltage sets for image data are equal to the high and low grayscale gamma curves T1 and T2 shown in FIG. 3, respectively. In this case, the signal controller 600 may generate a control signal which requests selection of one of the two grayscale voltage sets and provides the control signal to the data driver 500, instead of converting input image data into a high and low grayscale output images. The data driver 500 converts each image data into a grayscale voltage selected between two sets of grayscale voltages according to the control signal and sends the grayscale voltage out as a data voltage. Here, the schemes illustrated on FIGS. 4 and 5 may be applied.

While the present invention has been particularly shown and described with reference to exemplary embodiments thereof, it will be understood by those skilled in the art that various changes in form and details may be made therein without departing from the spirit and scope of the present invention as defined by the appended claims.

As described above, deterioration in display quality is suppressed due to a difference between the front and side visibilities by converting input image data into a combination of high and grayscale conversion data.

In addition, since there is no need to divide a pixel into two sub-pixels to have capacitive coupling, the aperture rate of a display device becomes high and thereby the quality of a display device is improved.

What is claimed is:

1. A driver for a display device having a plurality of pixels disposed in a matrix, comprising:
a signal controller receiving first and second input image data, converting the first input image data into first output image data having a grayscale higher than that of the first input image data and converting the second input image data into second output image data having a grayscale lower than that of the second input image data; and
a data driver converting the first and second output image data received from the signal controller into a first data voltage and a second data voltage and applying the first and second data voltages to corresponding pixels, respectively.

2. The driver for a display device of claim 1, wherein a ratio between the numbers of pixels applied with the first data voltage and the number of pixels applied with the second data voltage is a constant.

3. The driver for a display device of claim 2, wherein a gamma curve obtained from averaging gamma curves of the first output data and the second output data using the number of pixels to which each output data is applied as the weight is substantially equal to the gamma curves of the first and second input image data.

4. The driver for a display device of claim 2, wherein the first data voltage and the second data voltage are applied to a pixel in a ratio of the number of pixels to which each output data is applied.

5. The driver for a display device of claim 1, wherein the a ratio of the number of pixels applied with the first data voltage and the number of pixels applied with the second data voltage is 1:1.

6. The driver for a display device of claim 5, wherein an averaged gamma curve of a gamma curve of the first output data and that of the second output data using the ratio of 1:1 is substantially equal to a gamma curve of the first and second input image data.

7. The driver for a display device of claim 5, wherein the first data voltage and the second data voltage are applied to the adjacent pixels of the second data voltage and the first data voltage, respectively, within a frame.

8. The driver for a display device of claim 7, wherein the first data voltage is applied to a pixel in one frame and the second data voltage is applied to the respective pixel in adjacent frames.

9. The driver for a display device of claim 1, wherein a ratio of the number of pixels applied with the first data voltage and the number of pixels applied with the second data voltage is 1:3.

10. The driver for a display device of claim 9, wherein an averaged gamma curve of gamma curves of the first and second output data using the ratio of 1:3 is substantially equal to -gamma curves of the first and second input image data.

11. The driver for a display device of claim 9, wherein positions of the first data voltage and the second data voltage among a first four adjacent pixels in a frame are the same for a second four adjacent pixels within the frame.

12. The driver for a display device of claim 9, wherein the first data voltage is applied to one pixel among four adjacent pixels in one frame of four continuous frames and the second data voltage is applied to the remaining three pixels of the four adjacent pixels of the frame; and
wherein the first data voltage is assigned to a different one of each of the four adjacent pixels in each of the four continuous frames.

13. The driver for a display device of claim 9, wherein the first data voltage is applied to one pixel among four adjacent pixels, and the second data voltage is applied to the remaining three pixels of the four adjacent pixels.

14. The driver for a display device of claim 13, wherein the first data voltage is applied to a pixel in one frame among four continuous frames, and the second data voltage is applied to the respective pixel in remaining three frames of the four continuous frames.

15. The driver for a display device of claim 12, wherein a position of a pixel among the four adjacent pixels applied with the first data voltage is different within each frame of four continuous frames.

16. The driver for a display device of claim 1, wherein the signal controller comprises a storage element recording conversion data corresponding to the image data and its respective grayscale.

17. The driver for a display device of claim 16, wherein the storage element comprises:
a first memory element corresponding to first conversion data having a higher grayscale, the signal controller transmitting the first conversion data as the first output image data; and
a second memory element corresponding to second conversion data having a lower grayscale, the signal controller transmitting the second conversion data as the second output image data.

18. A display apparatus comprising:
a plurality of pixels disposed in a matrix;
a grayscale voltage generator which generates first and second grayscale voltage sets; and
a data driver which converts first image data into a first grayscale voltage among the first grayscale voltage set, applies the first grayscale voltage to a corresponding pixel as first data voltage and converts second image data into a second grayscale voltage among the second grayscale voltage set, and applies the second grayscale voltage to a corresponding pixel as second data voltage, wherein the pixels applied with the first data voltage are brighter than the pixels applied with the second data voltage.

19. A display apparatus comprising:
a plurality of pixels arranged in a matrix; and
a data driver which receives a plurality of input image data, converts the input image data into a data voltage, and applies the data voltage to the corresponding pixels,
wherein a plurality of input image data include first and second input image data having a same value,
wherein the first and second input image data are converted into first and second data voltage, respectively, and
wherein the luminance of a pixel applied with the first data voltage and the luminance of a pixel applied with the second data voltage are different from each other.

20. The driver of claim 19, wherein the difference of the luminance is two grades or more.

21. The driver of claim 19, wherein only one of the first and second data voltages is applied to each pixel, and there is a one-to-one correspondence between the input image data and the pixel.
